(19) United States
(12) Patent Application Publication
(10) Pub. No.: US 2026/0341939 A1
(43) Pub. Date: Oct. 29, 2026

(54) Cover Assembly, Energy Storage Cell, Battery Module and Method for Producing a Cover Assembly

(71) Applicant: BAYERISCHE MOTOREN WERKE AKTIENGESELLSCHAFT, München (DE)

(72) Inventors: Sebastian SCHARNER, Tuerkenfeld (DE); Seokyoon YOO, Muenchen (DE)

(21) Appl. No.: 19/107,094

(22) PCT Filed: Aug. 21, 2023
(86) PCT No.: PCT/EP2023/072888

§ 371 Date: Feb. 27, 2025

(30) Foreign Application Priority Data
Aug. 31, 2022 (DE) 10 2022 121 989.5

(51) Int. Cl. H01M 50/664; H01M 50/107; H01M 50/152; H01M 50/186; H01M 50/213; H01M 50/342; H01M 50/655

(52) U.S. Cl. CPC H01M 50/664; H01M 50/107; H01M 50/152; H01M 50/186; H01M 50/213; H01M 50/3425; H01M 50/655; H01M 2220/20

(57) ABSTRACT

A cover assembly for a cell housing of an energy storage cell has: an end plate with an attachment assembly, the end plate having an opening through which electrolyte can be filled into the cell housing and a circumferential groove; a first closure element configured to close the opening before filling of the cell housing and to be penetrated by a filling element for filling the cell housing; and a second closure element configured to close the opening after filling of the cell housing. In the installed state, the cover assembly is configured to enable the cell housing to be filled with an electrolyte. The circumferential groove is configured to enable the end plate to break open in the region of the groove if a certain excess pressure is reached or exceeded in the cell housing, so that an at least partial escape of the electrolyte is enabled through the broken open region.

### BACKGROUND AND SUMMARY

The present invention relates to a cover assembly, an energy storage cell, a battery module and a method for producing a cover assembly.

In the area of energy storage cells, in particular battery cells, such as lithium-ion battery cells, primarily cylindrical, prismatic and pouch-shaped battery cells are known. Battery cells for storing electrical energy play a central role in the area of what is known as electric mobility, both in vehicles with pure electric drive and in vehicles with hybrid drive. For example, a battery module for a 12 V starter battery can have four battery cells, whereas a high-voltage store can have a plurality of battery modules.

In the battery cells, an energy storage device and electrodes connected thereto can be arranged within a cell housing. Electric power can be tapped off from outside the cell housing via provided electrical connections to the electrodes. The energy storage device can have chemical connections, which can lead to gas emissions within the cell housing. In the event of a simultaneous high temperature, a high pressure can arise within the cell housing, as a result of which the danger of thermal runaway of the battery cell is increased.

It is an object of the present disclosure to specify a cover assembly, an energy storage cell, a battery module, a motor vehicle and a method for producing a cover assembly which is improved with respect to the aforementioned problems.

This object may be achieved by a cover assembly according to the independent claim, an energy storage cell, a battery module, a motor vehicle and a method for producing a cover assembly.

A first aspect of the solution relates to a cover assembly for a cell housing of an energy storage cell, wherein, in the installed state, the cover assembly is designed so as to enable the cell housing to be filled with an electrolyte, wherein the cover assembly has: an end plate with an attachment assembly, the end plate having an opening through which the electrolyte can be put into the cell housing and a circumferential groove; a first closure element, which is designed to close the opening before the filling of the cell housing and to be penetrated by a filling element for filling the cell housing; a second closure element, which is designed to close the opening after the filling of the cell housing. The circumferential groove is designed to enable the end plate to break open in the region of the groove if a certain excess pressure is reached or exceeded in the cell housing, so that an at least partial escape of the electrolyte through the broken-open region is made possible.

The terms “comprises”, “includes”, “encloses”, “exhibits”, “has”, “with” that may be used in this document or any other variant thereof are intended to cover a non-exclusive inclusion. Thus, for example, a method or a device which comprises or has a list of elements is not necessarily restricted to these elements but can include other elements which are not expressly listed or which are inherent to such a method or such a device.

Furthermore, if the opposite is not expressly specified, “or” relates to an inclusive or and not to an exclusive “or”. For example, a condition A or B is fulfilled by one of the following conditions: A is true (or present) and B is false (or not present), A is false (or not present) and B is true (or present), and both A and B are true (or present).

The terms “a” and “one”, as used here, are defined in the sense of “one or more”. The terms “another” and “a further” and any other variant thereof are to be understood in the sense of “at least one further”.

The term “a plurality” as used herein, is to be understood in the sense of “two or more”.

The term “configured” or “designed” to fulfil a specific function (and respective modifications thereof), as used herein, is to be understood to mean that the corresponding device is already present in a configuration or adjustment in which it can carry out the function or it is at least adjustable—i.e. configurable—such that it can carry out the function following appropriate adjustment. The configuration can be carried out, for example, via an appropriate adjustment of parameters of a process sequence or switches or the like for activating and deactivating functionalities or adjustments. In particular, the device can have a plurality of predetermined configurations or operating modes, so that the configuration can be carried out by way of a selection of one of these configurations or operating modes.

The term “electrode winding”, as used herein, is to be understood in particular as a device which, as an assembly of a galvanic cell, in particular a battery cell, is also used for the storage of chemical energy and for the discharge of electrical energy. To this end, the electrode winding has at least two electrodes, namely an anode and a cathode, and a separator, in particular an electrically insulating separator, which can at least partly accommodate an electrolyte. The anode, separator and cathode are wound around an axis to form an electrode winding. Before the discharge of electrical energy, stored electrical energy is converted into electrical energy. During the charging of the cell, the electrical energy supplied to the electrode winding is converted into chemical energy and stored. Particularly preferably, some electrodes are in particular electrically connected to one another.

The term “separator layer” or a “separator”, as used herein, is to be understood in particular as an electrically insulating device which divides and spaces an anode apart from a cathode. Preferably, a separator layer is applied to an anode layer and/or a cathode layer. Preferably, the separator layer is formed as an independent body. The separator layer or the separator can also at least partly accommodate electrolyte, the electrolyte preferably containing lithium ions. The electrolyte can also be electrochemically operatively connected to adjacent layers of the electrode stack. The shape of a separator preferably corresponds substantially to the shape of an anode of the electrode stack. Preferably, a separator is designed to be thin-walled, particularly preferably as a microporous film. Preferably, the separator layer or the separator is wetted with an additive which also increases the mobility of the separator layer or the separator. Particularly preferably, the wetting is carried out with an ionic additive. Preferably, the separator layer or the separator extends in at least some regions over a boundary edge of at least one electrode. Particularly preferably, the separator layer or the separator extends over all the boundary edges of adjacent electrodes.

The term “electrolyte”, as used here, is understood in particular as a liquid or solid material through which ions can be led, as a result of which a transport of current between electrodes of a battery, in particular between a cathode and an anode, is enabled. As distinct from the case of electronic conductivity (by electrons) in an electrode material, the electrolyte must be ionically conductive, i.e. conduct the electrical current by the transport of charged atoms or molecules (ions). The electrolyte is advantageously stable against decomposition chemically in a wide temperature window and electrochemically in the largest possible voltage window. Ideally, it is non-toxic and non-combustible and has at least a high flame point and a low heat of combustion. Liquid systems may be preferred because of better conductivity as compared with polymer and solid electrodes.

By way of the energy storage cell, according to the first aspect, it is possible that in the installed state of the cover assembly on a cell housing of an energy storage cell, when a certain pressure is reached or exceeded in the cell housing, the end plate can break open in the area of the circumferential groove. As a result, it is possible to prevent a pressure currently prevailing in the cell housing from rising further. As a result, a controlled, directed and therefore safe relief of pressure is preferably achieved. As a result, the cover assembly not only enables reliable and safe electrolyte filling under normal conditions but may also serve to dissipate an excess pressure in the cell occurring under certain circumstances, for example as a result of intense heating because of internal cell short-circuits. Furthermore, the cover assembly can be produced separately from the cell housing. This can be advantageous during the mounting of the cover assembly on the cell housing, since the opening, the first closure element, the attachment assembly and the groove can already be arranged or formed before the cover assembly is attached to the cell housing. The opening may be closed by the second connecting element only after the filling of the electrolyte. Forming the opening, for example by way of a drilling operation, when the cover assembly has already been attached to the cell housing can lead to contaminants, in particular material swarf, getting into the cell housing, which can impair the function of the energy storage cell. This can be avoided by separate production of the cover assembly.

Preferred embodiments of the cover assembly which, if not expressly excluded or technically impossible, can each be combined with one another and, with the further other aspects described, are described below.

In some embodiments, the first closure element has a membrane and/or a film, which is attached in the opening. A membrane or film is to be understood here as any thin flat structure, for example made of plastic, rubber, metal or other materials or a combination of two or more different materials which, in relation to its thickness, has a large flat extent. As a result, firstly good sealing of the opening and, secondly, good penetrability of the first closure element can be achieved. Preferably, the membrane or film is produced from an elastomeric material. This means that no or only relatively little electrolyte or solvent escapes at the point at which the filling element penetrates the membrane or film.

In some embodiments, the first closure element is designed to be pierced and/or punctured by a filling element formed as a hollow needle. Filling a closed cell housing can be carried out in this way.

In some embodiments, the second closure element is designed to be connected to the attachment assembly by a force fit, in particular by screwing, in order to close the opening, in particular to close it hermetically. For example, the opening can be provided with an internal thread and the second closure element with an external thread, so that the second closure element can be screwed into the opening. As a result, reliable sealing of the opening after the filling of the energy storage cell can be achieved in a particularly simple way.

In some embodiments, the second closure element is designed to be connected to the attachment assembly integrally, in particular by welding, in order to close the opening, in particular to close it hermetically. For example, for this purpose, flanges can be provided on the second closure element, which are welded or soldered to the attachment assembly of the filling collection. Reliable sealing of the opening after the filling of the cell can also be achieved in a simple way by this approach.

In some embodiments, the first closure element is releasably attached in the opening, so that the first closure element can be removed at least partly from the opening, in particular forced out, by the excess pressure. For example, a circumferential groove can be provided in the opening, in which the first closure element is retained. If the excess pressure in the cell exceeds a specific value, then the first closure element is released from the circumferential groove of the opening, and thus an excess pressure in the cell housing can be reduced.

In some embodiments, the second closure element has a bursting membrane or bursting disk, which is designed to at least partly open or free the opening in order to enable an at least partial escape of electrolyte through the opening when a specific excess pressure in the cell housing is reached or exceeded. A bursting membrane or bursting disk may comprise a suitable material such as, for example, aluminum, an aluminum alloy, steel or PTFE, and may be constituted such that, in the event that a specific excess pressure in the cell is reached or exceeded, it can burst and/or free the opening. As a result, a controlled, directed and therefore safe relief of pressure is preferably achieved. As a result, the cover assembly permits an excess pressure occurring in the cell under certain circumstances, for example as a result of intense heating because of internal cell short-circuits, to be dissipated.

The second aspect of the solution relates to an energy storage cell having: (i) a cell housing; (ii) two electrodes, which are arranged in the cell housing; (iii) a cover assembly according to the first aspect, wherein the cover assembly is attached to the cell housing, so that the cell housing is closed, in particular in a gas-tight manner.

A third aspect of the solution relates to a battery module having a plurality of energy storage cells according to the second aspect.

A fourth aspect of the solution relates to a motor vehicle having an electric drive or a hybrid drive and a battery module according to the third aspect.

A fifth aspect of the solution relates to a method of producing a cover assembly according to the first aspect, having the steps: (i) providing an end plate with a circular outline and a longitudinal axis (L) extending perpendicular to the circular outline; (ii) forming a substantially centrally arranged continuous opening along the longitudinal axis on the circular end plate; (iii) forming a groove extending circumferentially in relation to the longitudinal axis on a surface of the circular end plate; (iv) arranging an attachment assembly in an edge region of the opening; (v) arranging a first closure element for closing the opening, wherein, in the installed state, the first closure element is designed to close the opening before the filling of the cell housing with an electrolyte, and to be penetrated, in particular pierced or punctured, by a filling element for filling the housing, through which the electrolyte can be put into the cell housing; and (vi) arranging a second closure element in the installed state and after the filling of the cell housing, the closure element being designed to close the opening after the filling of the cell housing.

The features and advantages explained in relation to the first aspect of the solution also apply appropriately to the further aspects described.

### BRIEF DESCRIPTION OF THE DRAWINGS

Further advantages, features and possible applications emerge from the following description of preferred embodiments in conjunction with the figures, in which:

FIG. 1 shows, schematically, a battery cell according to one embodiment;

FIG. 2 shows, schematically, a cover assembly according to one embodiment;

FIGS. 3A to 3D show, schematically, production states of a cover assembly according to one embodiment; and

FIG. 4 shows a flowchart to illustrate a preferred embodiment of a method for producing a battery cell.

In the figures, the same designations are continuously used for the same or mutually corresponding elements.

### DETAILED DESCRIPTION OF THE DRAWINGS

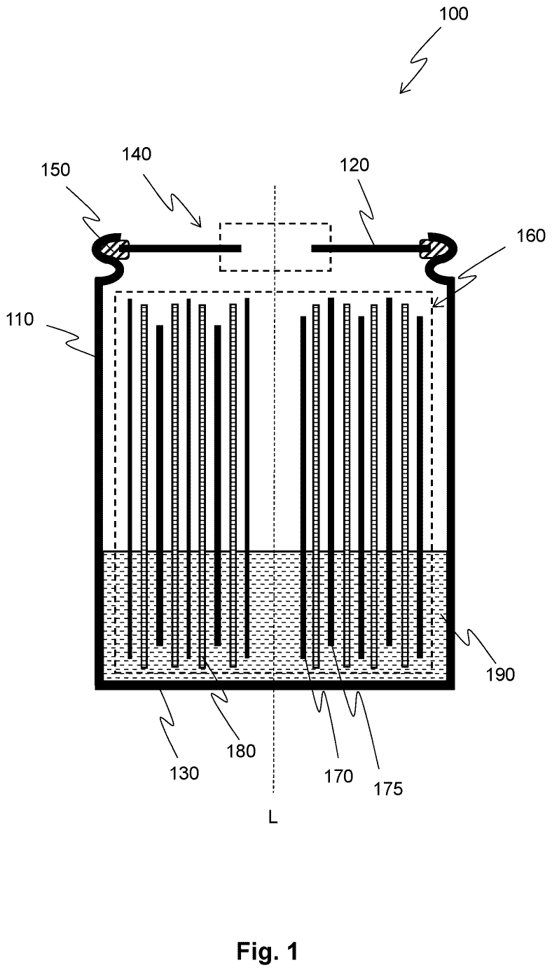

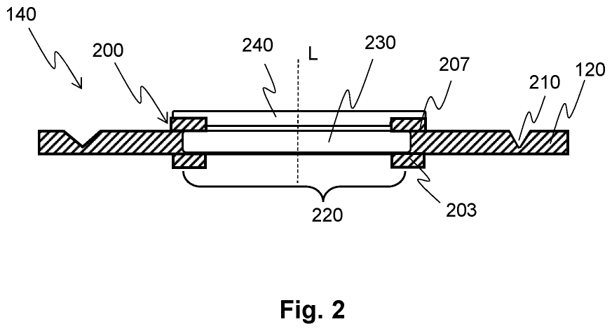

FIG. 1 shows, schematically, a battery cell 100 according to one embodiment. The battery cell 100 has a hollow-cylindrical cell housing 110 with a longitudinal axis L. The cell housing 110 can likewise be designed in the shape of a cube. The cell housing 110 has an electrically conductive material. However, it is also conceivable that the cell housing 110 has an electrically insulating material. The cell housing 110 is closed on one side by a baseplate 130. On the side opposite the baseplate 130, the cell housing 110 is closed by a cover assembly 140. The cover assembly 140 has an end plate 120 and will be described in more detail in FIG. 2. The end plate 120 is arranged in a circumferential groove of the cell housing 110, and an electrically insulating element 150, which insulates the end plate 120 electrically with respect to the cell housing 110, is arranged between the end plate 120 and the groove. In addition, the electrically insulating element 150 acts in a gas-tight manner, so that the cell housing 110 can be closed in a gas-tight manner by the cover assembly 140. The opening of the groove points toward the longitudinal axis L.

However, it is also conceivable that no electrically insulating element 150 is arranged between the end plate 120 and the groove. This may be practical when the cell housing 110 has an electrically insulating material. It is also conceivable that an electrode of one polarity is led through the baseplate 130 of the cell housing 110, the lead-through being electrically insulated with respect to the cell housing 110 and likewise being located in the baseplate 130. In this case, too, the cover can be connected directly to the cell housing 110, in particular welded.

An electrode winding 160 is arranged in the cell housing 110. The electrode winding 160 has electrodes with a first, positive polarity 170, and electrodes with a second, negative polarity 175. However, the electrode winding 160 can also be built up in such a way that the first polarity is negative and the second polarity is positive. The electrode winding 160 is arranged in the cell housing 110 such that electrodes of positive polarity 170 and electrodes of negative polarity 175 are arranged alternately in the radial direction. In each case, a separator 180 is arranged between the positive-polarity electrodes 170 and the negative-polarity electrodes 175, so that the electrodes 170, 175 of different polarity are electrically insulated from one another, the separator 180 having an electrically insulating material. In addition, an electrolyte 190 is illustrated schematically in the cell housing 110. The electrolyte 190 is put into the cell housing 110 through the cover assembly 140.

FIG. 2 shows, schematically, a cover assembly 140 according to one embodiment. The cover assembly 140 has an end plate 120. The end plate 120 has a groove 210 extending circumferentially in relation to a longitudinal axis L. The groove 210 may have a triangular cross section. Likewise, the cross section can have a semicircular, rectangular or other shape. The end plate 120 has a lower thickness in the area of the groove 210 than the thickness of the end plate 120 during its production, and as a result can break open more easily in these areas.

The end plate 120 has an attachment assembly 200 with an opening 220 arranged substantially centrally in relation to the end plate 120. The attachment assembly 200 is arranged symmetrically relative to the longitudinal axis L. The attachment assembly 200 has a first supporting ring 203, which is arranged on one side of the end plate 120, and a second supporting ring 207, which is arranged on another side of the end plate 120. The opening 220 is closed by a membrane 230. Likewise, instead of the membrane 230, a foil can close the opening 220. By way of a filling tool, in particular a hollow needle (not shown here), which is suitable to be pushed through the membrane 230, an electrolyte 190 can be put into the housing 110 through the membrane 220. After the filling and the withdrawal of the filling tool from the cell housing 110 and the membrane 220, the membrane 230 closes. The closure is intended to prevent considerable quantities of the electrolyte 190 from being able to escape from the cell housing 110. In particular in electrolytes 190 of which the boiling temperature lies below room temperature, boiling off can occur. However, the closure of the membrane 230 is sufficient only for the filling operation. In operation of the battery cell 100, a more stable and more permanent closure is required. Therefore, a cover 240 is additionally provided, which can be metal and is attached in a gas-tight manner to the attachment assembly 200.

In the event of an excess pressure within the closed cell housing 110, provision is made for the end plate 120 to break open in the area of the groove 210. As a result, gas or else the electrolyte 190 can escape from the cell housing 110 and a pressure rising further can be avoided.

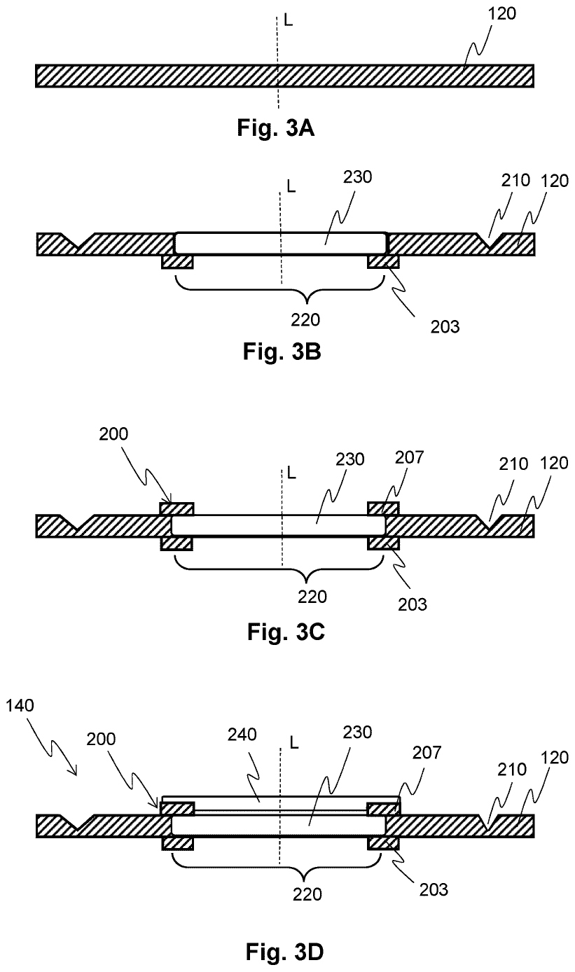

In FIGS. 3A to 3D, production states of a cover assembly according to one embodiment are shown schematically.

In FIG. 3A, an end plate 120 having a longitudinal axis L is shown in a side view. In the side view of the end plate 120, the longitudinal axis L extends substantially perpendicular to the end plate 120.

In FIG. 3B, the end plate 120 has a substantially centrally arranged opening 220. A first supporting ring 203 is attached to one side of the opening 220. The attachment is preferably integral. The first supporting ring 203 is arranged axially symmetrically relative to the longitudinal axis L. The end plate 120 further has a circumferential groove 210 which, in relation to the longitudinal axis L, is arranged radially further out than the first supporting ring 203. The opening 220 is closed by a membrane 230, which rests on the first supporting ring 203 in the opening 220.

In FIG. 3C, an arrangement according to FIG. 3B is shown, wherein a second supporting ring 207 is additionally attached to another side of the opening 220. This attachment is also preferably integral. As a result, the membrane 230 is arranged between the first supporting ring 203 and the second supporting ring 207.

The arrangement shown in FIG. 3D corresponds to the arrangement from FIG. 2. In comparison with FIG. 3C, with reference to the drawing plane, a cover 240 is attached in the upper area of the attachment assembly 200.

It is also conceivable that, instead of the first supporting ring 203 and the second supporting ring 207, the attachment assembly 200 is formed in one piece and forms a circumferential groove. The groove is opened in one section such that the membrane 230 can be arranged in the groove. The membrane 230 is preferably deformable. This opening can then be closed by mechanical deformation. The one-piece attachment assembly 200 can be attached integrally to an inner side of the opening 220 in a corresponding way (not shown here).

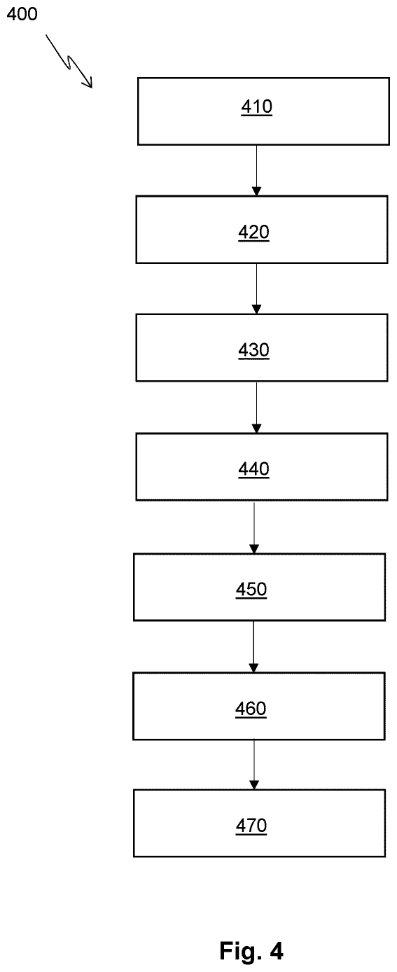

In FIG. 4, a flowchart 400 to illustrate one embodiment of a method for producing a cover assembly 140 of one embodiment is shown.

In a first step 410 of the method, an end plate 220 having a circular outline and a longitudinal axis L extending perpendicular to the circular outline is provided.

In a further step 420 of the method, a substantially centrally arranged continuous opening 220 along the longitudinal axis L is formed on the circular end plate 120. The opening 220 can in particular be formed by a drilling step.

In a further step 430 of the method, a groove 210 extending circumferentially in relation to the longitudinal axis L is formed on a surface of the circular end plate 120. The circumferential groove 210 can in particular be formed by milling or laser engraving.

In a further step 440 of the method, an attachment assembly 200 is arranged on the edge region of the opening 220. In particular, the attachment assembly 200 can have a first supporting ring 203 and a second supporting ring 207, wherein one of the supporting rings 203, 207 is attached to the end plate 120, and the other supporting ring 203, 207 is provided during the arrangement.

In a further step 450 of the method, a membrane 230 closing the opening 220 is arranged, wherein the membrane 230 is designed, in the installed state, to close the opening 220 before the filling of the cell housing 110 with an electrolyte 190 and to be penetrated, in particular pierced or punctured, by a filling element for filling the housing, through which the electrolyte 190 can be put into the cell housing 110. During the closure of the opening, the membrane 230 is placed on that supporting element 203, 207 which is attached to the end plate 120.

In a further step 460, the other supporting ring 203, 207 which has been provided is placed on the opening 220 under contact pressure. This other supporting ring 203, 207 is then integrally connected to the end plate 120, so that the membrane 230 is arranged between the two supporting rings 203, 207. It is also conceivable that one of the supporting rings 203, 207 or both supporting rings 203, 207 is/are connected to the end plate 120 by a force fit. The integral connection can be made by a welding operation, and the force-fitting connection can be made by a screw connection.

In a further step 470 of the method, a cover 240 is arranged in the installed state and after the filling of the cell housing 110. The cover is designed to close the opening 220 after the filling of the cell housing 110.

While at least one exemplary embodiment has been described above, it should be noted that a large number of variations from this exist. It should also be noted that the exemplary embodiments described represent only non-limiting examples and it is not intended as a result to restrict the scope, applicability or configuration of the devices and methods described here. Instead, the preceding description will supply those skilled in the art with a guide to implementation of at least one exemplary embodiment, it being obvious that various changes can be made in the functioning and the arrangement of the elements described in an exemplary embodiment without departing from the object respectively defined in the appended claims and its legal equivalents.

### LIST OF REFERENCE NUMBERS

100 Battery cell
110 Cell housing
120 End plate
130 Baseplate
140 Cover assembly
150 Insulating element
160 Electrode winding
170 Electrodes of positive polarity
175 Electrodes of negative polarity
180 Separate
190 Electrolyte
200 Attachment assembly
203 First supporting ring
207 Second supporting ring
210 Groove
220 Opening
230 Membrane
240 Cover
400 Flowchart to illustrate one embodiment of a method for producing a cover assembly
410 Provision of an end plate
420 Formation of a substantially centrally arranged continuous opening
430 Formation of a circumferential groove
440 Arrangement of an attachment assembly
450 Arrangement of a membrane
460 Connection of the attachment assembly
470 Arrangement of a cover

1-11. (canceled)

12. A cover assembly for a cell housing of an energy storage cell, wherein, in an installed state, the cover assembly is designed so as to enable the cell housing to be filled with an electrolyte, the cover assembly comprising:
an end plate with an attachment assembly, the end plate including:
a circumferential groove in a surface thereof; and
an opening through which the electrolyte can be put into the cell housing;
a first closure element configured to close the opening before a filling of the cell housing and to be penetrated by a filling element for filling the cell housing;
a second closure element configured to close the opening after the filling of the cell housing;
wherein the circumferential groove is configured to enable the end plate to break open in the region of the circumferential groove, forming a broken-open region, when a certain excess pressure is reached or exceeded in the cell housing, so that an at least partial escape of the electrolyte is enabled through the broken-open region.

13. The cover assembly according to claim 12, wherein the circumferential groove extends circumferentially in relation to a longitudinal axis L of the cover assembly.

14. The cover assembly according to claim 12, wherein the opening is arranged substantially centrally in relation to the end plate.

15. The cover assembly according to claim 12, wherein the first closure element has a membrane and/or a foil attached in the opening.

16. The cover assembly according to claim 12, wherein the first closure element is configured to be pierced and/or punctured by the filling element, and
wherein the filling element is formed as a hollow needle for filling the cell housing.

17. The cover assembly according to claim 12, wherein the second closure element is configured to be connected to the attachment assembly by a form fit in order to close the opening.

18. The cover assembly according to claim 12, wherein the second closure element is designed to be connected integrally to the attachment assembly in order to close the opening.

19. The cover assembly according to claim 12, wherein the first closure element is releasably attached in the opening, whereby the first closure element is configured to be at least partly removable from the opening by the certain excess pressure.

20. The cover assembly according to claim 12, wherein the second closure element has a bursting membrane or bursting disk configured to at least partly open or free the opening, thereby enabling partial escape of the electrolyte through the opening when the certain excess pressure is reached or exceeded in the cell housing.

21. An energy storage cell having:
a cell housing;
two electrodes arranged in the cell housing;
a cover assembly according to claim 12, wherein the cover assembly is attached to the cell housing, wherein the cell housing is closed.

22. A battery module having a plurality of energy storage cells according to claim 21.

23. A motor vehicle having an electric drive or a hybrid drive and a battery module according to claim 22.

24. A method for producing a cover assembly, the method comprising:
providing an end plate with a circular outline and a longitudinal axis (L) extending perpendicular to the circular outline;
forming a substantially centrally-arranged continuous opening along the longitudinal axis (L) on the circular end plate;
forming a groove running circumferentially in relation to the longitudinal axis (L) on a surface of the circular end plate;
arranging an attachment assembly in an edge region of the opening;
arranging a first closure element for closing the opening, wherein the first closure element is configured, in an installed state, to close the opening before a filling of the cell housing with an electrolyte, and to be penetrated by a filling element for filling the cell housing, whereby an electrolyte can be put into the cell housing; and
arranging a second closure element in the installed state and after the filling of the cell housing, the second closure element being configured to close the opening after the filling of the cell housing.
